(19) United States
(12) Patent Application Publication
(10) Pub. No.: US 2015/0198865 A1
(43) Pub. Date: Jul. 16, 2015

(54) ROTATABLE CAMERA DEVICE

(71) Applicant: Beseye Cloud Security Co., Ltd., Taipei City (TW)

(72) Inventors: TSE-MING CHANG, Taipei City (TW); PEI-YUN TSAI, Taipei City (TW); CHENG-HAN TU, Taipei City (TW)

(73) Assignee: Beseye Cloud Security Co., Ltd., Taipei City (TW)

(21) Appl. No.: 14/262,703

(22) Filed: Apr. 25, 2014

(30) Foreign Application Priority Data
Jan. 13, 2014 (TW) 103200692

(51) Int. Cl. G03B 17/56

(52) U.S. Cl. CPC G03B 17/561

(57) ABSTRACT

The present invention relates to a camera device, wherein the camera device comprising a base with a fillister; a body with a spherical unit and a neck; and a camera configured onto the body. The spherical unit fits the fillister to form a joint allowing a wide range of rotation in all direction. The base further comprises a first fixing unit and a second fixing unit. Therefore, the camera device is able to be easily mounted onto a targeted surface; and, the camera field of view is able to be rapidly optimized toward a specific direction.

### BACKGROUND OF THE INVENTION

1. Technical Field

At least one disclosed embodiment in accordance with the present invention relates to a camera device. More particularly, at least one disclosed embodiment relates to an internet protocol camera supporting a wide range of rotation.

2. Description of the Related Art

Recently, camera device has been applied intensively to various circumstances including observing crime hotspots, monitoring children or senior citizens, and establishing video links. Camera therefore largely increases convenience and security nowadays.

However, conventional camera devices in this field usually are manufactured with several connected arms and physical joints, which led to inconvenience during device mounting and difficulties in camera rotating. Users usually suffer from failures when trying to adjust the camera to a specific position or angle, since the unsmooth surfaces and rectangular shapes of camera devices largely restrict the camera device from movements. These situations are encountered intensively when attempting to mount the camera device to places such as wall, ceiling, or corner.

The physical features of camera devices by conventional camera devices largely refrain users from convenience and ease, since the complexities in arms and joints require an enormous amount of time to build a camera system.

### SUMMARY

Aiming to solve the problems led by conventional camera devices, at least one embodiment in accordance with the present invention provides a novel camera device which comprising a base, a body, and a camera. Wherein the camera is connected onto the body and the body is placed onto the base.

The base comprises a fillister, wherein the fillister is a concave and, to increases the friction per se, is made of natural rubber or synthetic rubber. The body is formed in a gourd-shape, a dumbbell-shape, or a teardrop-shape. A neck, on the body, is configured to a spherical unit which is able to fit with the fillister. The spherical unit further comprises a second magnetic unit magnetically attractive to a first magnetic unit configured in the base. Wherein the magnetic force induced by the first magnetic unit and the second magnetic unit is able to attach the spherical unit to the fillister to form a joint allowing the body to rotate and spin freely within a hemispherical region.

In a preferred embodiment, the body, when centered on the spherical unit, is allowed to perform a horizontal rotation in 360 degree and a vertical rotation in 180 degree; in addition, the camera per se, with the center of the camera, is able to further rotate in 360 degree.

In another embodiment, a heavy unit is configured in the base for stabilizing the base and the body. The heavy unit also provides the ability as a buffer to balance the movements of the centroid during rotations, and therefore protect the body and the camera from collisions. Since electronic elements in camera are highly interfered and easily got wrecked by magnetic force, the neck places the camera a distance away from the first magnetic unit and the second magnetic unit to protect the camera from the magnetic forces.

In yet another embodiment, the camera device may further comprise a first fixing unit, connected onto the bottom of the base, and a second fixing unit. The second fixing unit comprises at least one first combining unit, and the first fixing unit comprises at least one second combining unit; wherein the at least one first combining unit is a mortise or a concave, and the at least one second combining unit is a tenon or a convex; or, on the contrary, the at least one first combining unit is a tenon or a convex, and the second combining unit is a mortise or a concave. The second fixing unit further comprises at least one fixing hole for fixing the second fixing unit onto a surface with nails or fixtures. The camera device is then able to be mounted onto the surface by combining the first combining unit and the second combining unit. In this embodiment, the camera device is able to be mounted onto a wall, a ceiling, or a surface of an object easily and rapidly. Besides, since sizes of the base and the second fixing unit are relative smaller, the requirements for a place for mounting a camera device are relative low.

The camera device in accordance with the present invention provides advantages such as easily adjusting the direction of camera to optimize the camera recording field, smoothly rotating the body without physical hindrances, fast mounting, and suitable for a variety of places under different situations.

### BRIEF DESCRIPTION OF THE DRAWINGS

FIG. 1 is a front plan view of one embodiment in accordance with the present invention.

FIG. 2 is a side plan view of one embodiment in accordance with the present invention.

FIG. 3 is a top plan view of one embodiment in accordance with the present invention.

FIG. 4(a) is a cross-sectional view of one embodiment in accordance with the present invention in the first position.

FIG. 4(b) is a cross-sectional view of one embodiment in accordance with the present invention in the second position.

FIG. 4(c) is a cross-sectional view of one embodiment in accordance with the present invention in the third position.

FIG. 5(a) is a front plan view of an exemplary body in accordance with the present invention.

FIG. 5(b) is a top perspective view of an exemplary base in accordance with the present invention.

FIG. 6(a) is a bottom perspective view of an exemplary base with an exemplary first fixing unit in accordance with the present invention.

FIG. 6(b) is a perspective view of an exemplary second fixing unit in accordance with the present invention.

### DESCRIPTION OF THE PREFERRED EMBODIMENTS

In a general aspect, at least one embodiment in accordance with the present invention relates to a camera device. More particularly, at least one embodiment relates to an internet protocol camera supporting a wide range of rotation. The embodiments and drawings provided here show different aspects of the present invention. However, the present invention are neither limited to any embodiment nor drawing thereof.

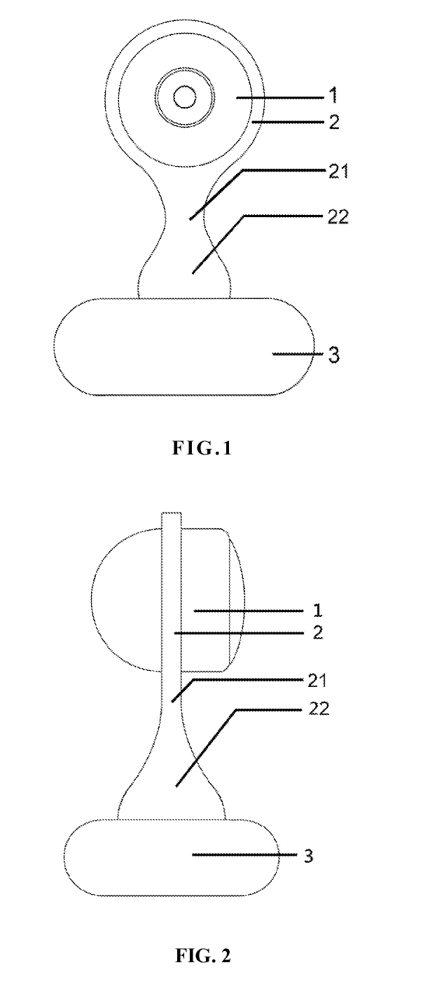

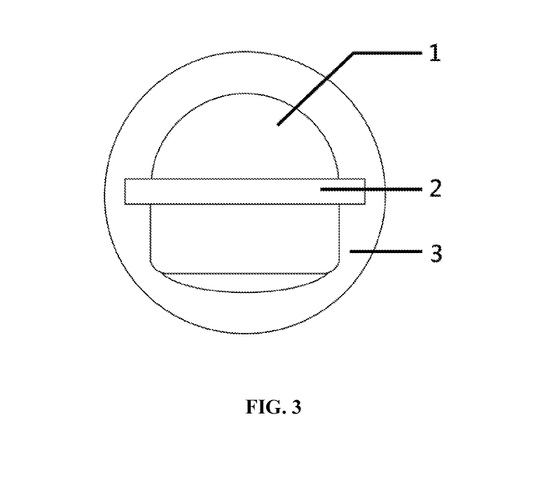

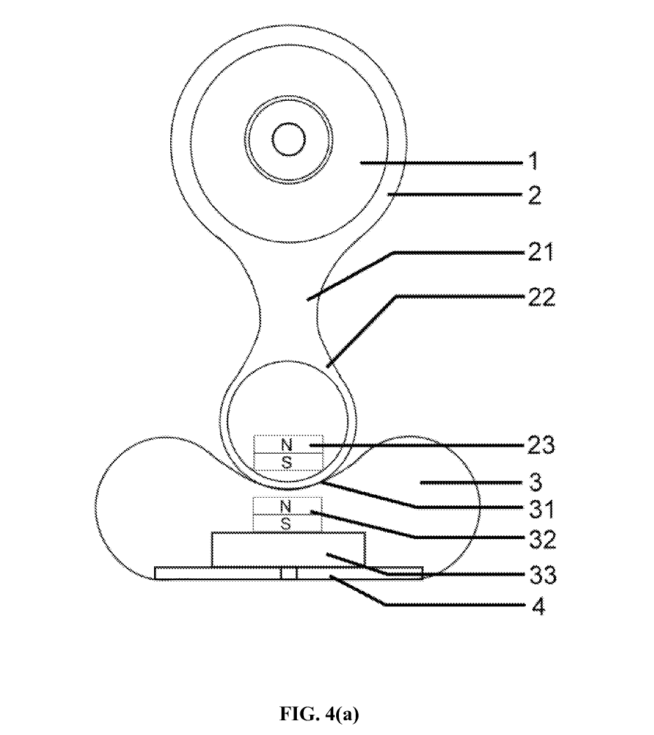

FIGS. 1-3 represents an embodiment in accordance with the present invention. FIG. 1 illustrates a front plan view of the embodiment; FIG. 2 illustrates a side plan view of the embodiment; and, FIG. 3 illustrates a top plan view of one embodiment. In this embodiment, the camera device comprises a camera 1, a body 2, a neck 21, a spherical unit 22 and a base 3. Wherein the camera 1 is configured onto the body 2; and, the neck 21 of the body 2 is configured in-between the spherical unit 22 and the camera 1 to support the camera 1. The spherical unit 22 is then placed onto the base 3.

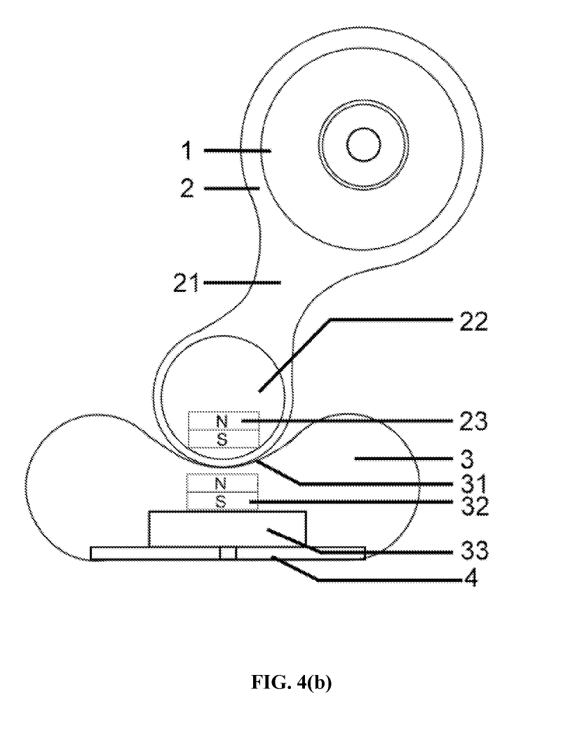

FIGS. 4(a)-(c) represent another embodiment in accordance with the present invention. FIG. 4(a) illustrates a cross-sectional view of the embodiment in the first position; FIG. 4(b) illustrates a cross-sectional view of the embodiment in the second position; FIG. 4(c) illustrates a cross-sectional view of the embodiment in the third position. As shown in FIGS. 4(a)-(c), a spherical unit 22 fits a fillister 31 of a base 3 to form a joint allowing a body 2 to rotate in a range in all directions. The fillister 31 may formed of natural rubber or synthetic rubber to increase the friction between the spherical unit 22 and the fillister 31 which stabilizes the body 2 in steady-state after movements; more particularly, the fillister 31 may formed of one selecting from the group consisting of Polyisoprene rubber, Methyl Vinyl Silicone rubber, Polysiloxane rubber, Polybutadiene, Styrene Butadiene rubber, Polychloroprene rubber, and Hydrogenated Nitrile Butadiene rubber.

The embodiment illustrated in FIGS. 4(a)-(c) further shows that a first magnetic unit 32 is configured in the base 3 and a second magnetic unit 23 is configured in the spherical unit 22. The first magnetic unit 32 and the second magnetic unit 23 together contribute to a magnetic connection between the body 2 and the base 3. The magnetic connection allows the body 2 attaches to the base 3 while remaining the ability to rotate and spin with ease. A neck 21, configured in-between the spherical unit 22 and a camera 1, keeps the camera 1 a distance away from the magnetic field created by the first magnetic unit 32 and the second magnetic unit 23; hence, the camera 1 is protected from being interfered by the magnetic forces.

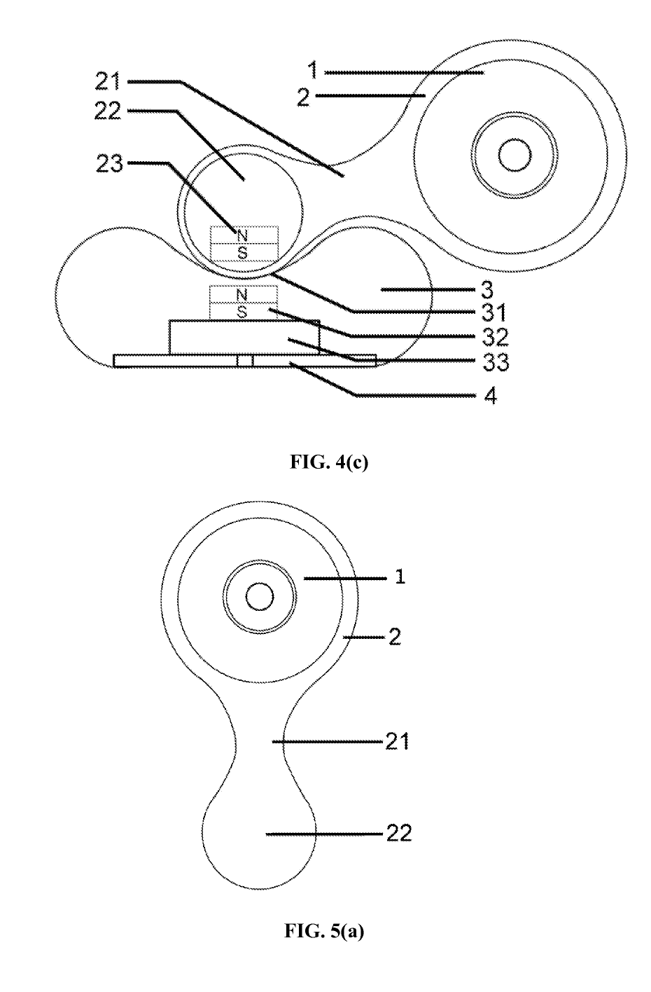

FIG. 5(a) and FIG. 5(b) represent yet another embodiment in accordance with the present invention. FIG. 5(a) illustrates a front plan view of an exemplary body in the embodiment. As shown in FIG. 5(a), a body 2 is formed in a gourd-shape or a dumbbell-shape. A spherical unit 22 enables the body 2, along with a camera 1, the ability to rotate and spin freely. The body 2 may also be formed in a teardrop-shape (not shown). FIG. 5(b) illustrates a top perspective view of an exemplary base in accordance with the embodiment. As shown in FIG. 5(b), the base 3 comprises a fillister 31 which is able to fit with the spherical unit 22 of the body 2.

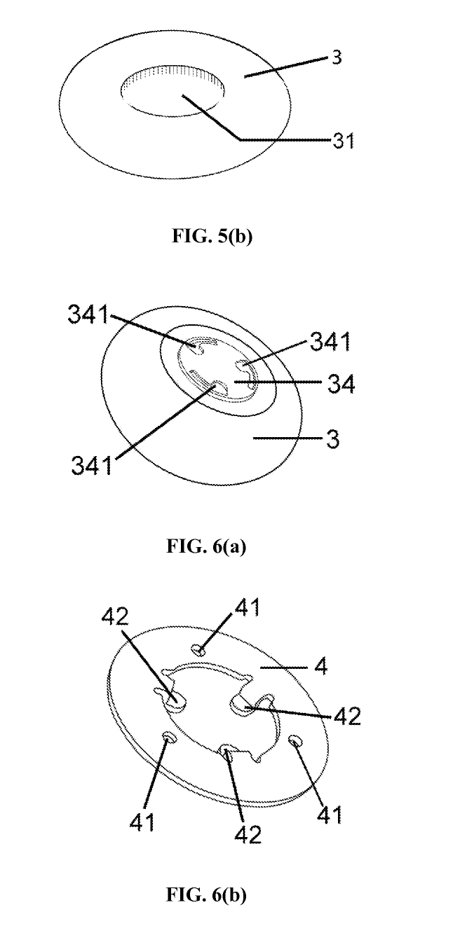

FIG. 6(a) and FIG. 6(b) represent an exemplary base in accordance with the present invention. FIG. 6(a) is a bottom perspective view of an exemplary base with an exemplary first fixing unit, wherein the first fixing unit 34 is configured to the bottom of the base 3. As shown in FIG. 6(a), the first fixing unit 34 comprises three second combining units in this exemplary base. FIG. 6(b) is a perspective view of an exemplary second fixing unit. As shown in FIG. 6(b), the second fixing unit 4 comprises three fixing holes 41 and three first combining units 42, wherein the three first combining units are able to combine with the three second combining units in FIG. 6(a). The second fixing unit, with nails or fixtures, is able to be fixed on a wall via the three fixing holes 41.

What is claimed is:

1. A camera device comprising:
a base with a fillister;
a body with a spherical unit and a neck; and
a camera configured on the body;
wherein the spherical unit fits the fillister to form a joint allowing the body to rotate.

2. The camera device according to claim 1, wherein the fillister is made of natural rubber or synthetic rubber.

3. The camera device according to claim 1, wherein the base further comprises a first fixing unit.

4. The camera device according to claim 1, wherein the base further comprises a heavy unit.

5. The camera device according to claim 3, wherein the base comprises a second fixing unit paired with the first fixing unit; the second fixing unit further comprises at least one first combining unit.

6. The camera device according to claim 5, wherein the first fixing unit further comprises at least one second combining unit for combining with the at least one first combining unit.

7. The camera device according to claim 5, wherein the second fixing unit further comprises at least one fixing hole.

8. The camera device according to claim 1, wherein the base further comprises a first magnetic unit.

9. The camera device according to claim 1, wherein the body is formed in a gourd-shape, a dumbbell-shape, or a teardrop-shape.

10. The camera device according to claim 8, wherein the spherical joint further comprises a second magnetic unit; the first magnetic unit and the second magnetic unit are mutually attractive to each other.

11. The camera device according to claim 1, wherein the camera is rotatable per se.

12. The camera device according to claim 6, wherein the at least one first combining unit is a mortise or a concave, and the at least one second combining unit is a tenon or a convex.

13. The camera device according to claim 6, wherein the at least one first combining unit is a tenon or a convex, and the second combining unit is a mortise or a concave.
